(19) United States
(12) Patent Application Publication
(10) Pub. No.: US 2003/0042064 A1
(43) Pub. Date: Mar. 6, 2003

(54) Steering rotation angle detecting apparatus of power steering system

(76) Inventors: Junya Takekawa, Haga-gun (JP); Akira Fujisaki, Haga-gun (JP)

Correspondence Address: ROSENTHAL & OSHA L.L.P., 1221 MCKINNEY AVENUE, SUITE 2800, HOUSTON, TX, 77010, US

(21) Appl. No.: 10/098,797

(22) Filed: Mar. 15, 2002

(30) Foreign Application Priority Data
Aug. 28, 2001 (JP) 2001-258648

(51) Int. Cl. B62D 5/04

(52) U.S. Cl. 180/444

(57) ABSTRACT

A steering rotation angle detecting apparatus of a power steering having a driving force of a motor applied to a steering pinion shaft via a speed reduction mechanism so as to assist a steering, is disclosed. The steering rotation angle detecting apparatus comprises a steering pinion shaft rotation position detecting means for detecting a rotation position of the steering pinion shaft with respect to a fixed member, a motor phase detecting means for detecting cyclic rotation phase states of the motor, and a steering rotation angle detecting means for detecting an absolute rotation angle over 360 degrees of the steering pinion shaft on the basis of a steering pinion shaft rotation position information detected by the steering pinion shaft rotation position detecting means and a motor phase information detected by the motor phase detecting means. A speed reduction ratio of the speed reduction mechanism is set so that the rotation phase states of the motor at cycles of 360 degrees of the steering pinion shaft rotation position are different.

### BACKGROUND OF THE INVENTION

1. Field of the Invention

The present invention relates to an apparatus for detecting an absolute rotation angle of a steering system, such as a steering system which is about three times rotated from a left steering limit to a right steering limit.

2. Description of the Related Art

As a structure for detecting a steering rotation angle of a steering wheel, there is generally an example described in Japanese Patent Application Laid-Open (JP-A) No. 8-101026 or the like.

The structure described in the publication mentioned above is an incremental type rotary encoder structured such that circular ring-like slit plates on which radial slits are formed at a predetermined uniform interval in a lower surface side of a steering wheel are concentrically mounted. An optical sensor at a fixed position detects the slits on the slit plates rotating together with the steering wheel. A rotation angle of the steering wheel is determined by a detected slit number.

Further, there is also an absolute type rotary encoder structured such that a binary n bit code is cut in slits so as to determine an absolute rotation angle.

However, in the case of the former incremental type encoder, the structure is made such that an absolute rotation angle at the present time is always held and a new rotation angle of the steering wheel is determined by adding or reducing the slit number detected by the rotation. Accordingly, once a displacement is generated, the rotation angle with keeping the displacement is thereafter determined, so that a specific mechanism for correcting the displacement such as a starting point correction or the like is required.

Further, the latter absolute type encoder can detect the absolute rotation angle without requiring the displacement correction. However, it is not possible to detect the rotation angle over 360 degrees as it is.

### SUMMARY OF THE INVENTION

The present invention relates to a steering rotation angle detecting apparatus of a power steering system which can detect an absolute rotation angle over 360 degrees in a pinion shaft.

In accordance with one embodiment of the present invention, there is disclosed a steering rotation angle detecting apparatus of a power steering system having a driving force of a motor applied to a steering pinion shaft via a speed reduction mechanism to assist a steering. The steering rotation angle detecting apparatus comprises a steering pinion shaft rotation position detecting means for detecting a rotation position of the steering pinion shaft with respect to a fixed member; a motor phase detecting means for detecting cyclic rotation phase states of the motor; and a steering rotation angle detecting means for detecting an absolute rotation angle over 360 degrees of the steering pinion shaft on the basis of a steering pinion shaft rotation position information detected by the steering pinion shaft rotation position detecting means and a motor phase information detected by the motor phase detecting means.

A speed reduction ratio of the speed reduction mechanism is set so that the rotation phase states of the motor at cycles of 360 degrees of the steering pinion shaft rotation position are different.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings

FIG. 1 is a schematic back elevational view of a whole of an electrically driven power steering apparatus according to an embodiment of the present invention;

FIG. 2 is a cross sectional view of an interior portion of a gearbox;

FIG. 3 is a development view of a motor and an armature winding of a rotor;

FIG. 4 is a chart showing respective changes of a motor phase state, a number of rotation of the steering system, a position of rotation of the steering system, and an absolute rotation angle of the steering system, when the motor rotation number is around the first lap;

FIG. 5 is a chart showing respective changes of a motor phase state, a number of rotation of the steering system, a position of rotation of the steering system, and an absolute rotation angle of the steering system, when the motor rotation number is around the seventeenth lap;

FIG. 6 is a chart showing respective changes of a motor phase state, a number of rotation of the steering system, a position of rotation of the steering system, and an absolute rotation angle of the steering system, when the motor rotation number is around the thirty-third lap; and

FIG. 7 is a chart showing respective changes of a motor phase state, a number of rotation of the steering system, a position of rotation of the steering system, and an absolute rotation angle of the steering system, when the motor rotation number is around the forty-ninth lap.

### DESCRIPTION OF THE PREFERRED EMBODIMENTS

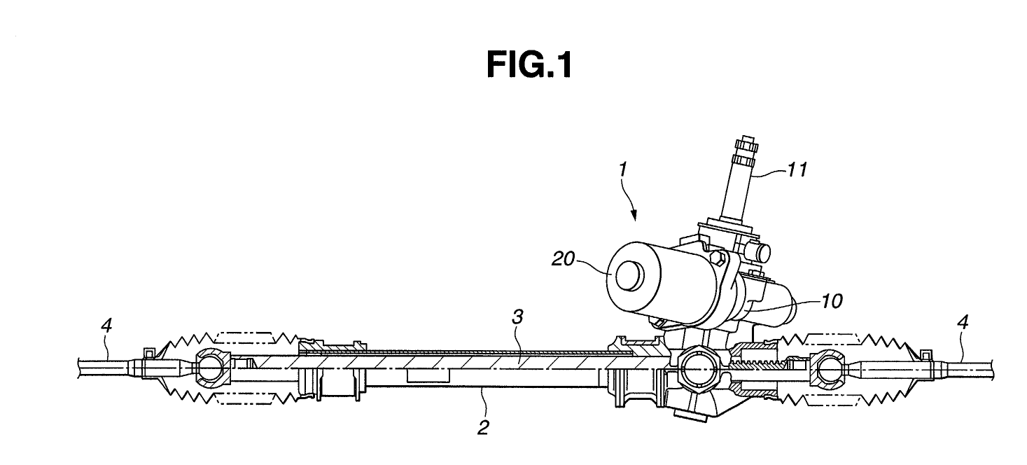

A description will be given below of an embodiment according to the present invention with reference to FIGS. 1 to 7.

FIG. 1 is a schematic back elevational view of an electrically driven power steering apparatus 1 according to an embodiment of the present invention.

The electrically driven power steering apparatus 1 is structured such that a rack shaft 3 is received within a substantially cylindrical rack housing 2 directed in a lateral direction of a vehicle (coinciding with a lateral direction in FIG. 1) in such a manner as to freely slide in a laterally axial direction.

Tie rods 4 and 4 are connected to both end portions of the rack shaft 3 protruding out from both end openings of the rack housing 2 via joints. The tie rods 4 and 4 are moved according to a movement of the rack shaft 3. Steered wheels of the vehicle are steered via a steering mechanism.

A steering gearbox 10 is provided in a right end portion of the rack housing 2.

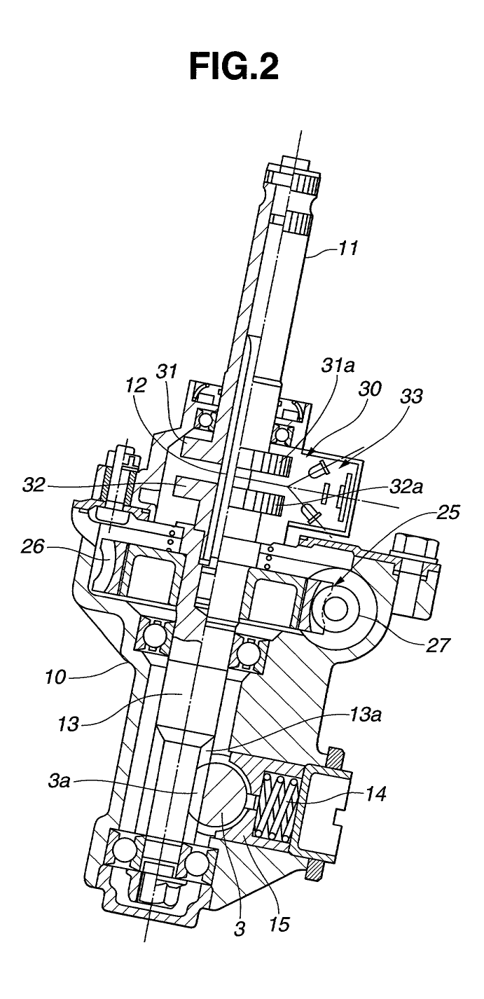

Relating to FIGS. 1 and 2, an input shaft 11 connected to a steering shaft with which a steering wheel (not shown) is integrally mounted, via a joint, is rotatably pivoted to the steering gearbox 10 via a bearing. The input shaft 11 is connected to a steering pinion shaft 13 so as to be relatively twisted via a torsion bar 12 within the steering box 10.

A helical gear 13a of the steering pinion shaft 13 is engaged with a rack gear 3a of the rack shaft 3.

Accordingly, a steering force transmitted to the input shaft 11 according to the rotating operation of the steering wheel rotates the steering pinion shaft 13 via the torsion bar 12 so as to slide the rack shaft 3 in the laterally axial direction due to the engagement between the helical gear 13a of the steering pinion shaft 13 and the rack gear 3a.

The rack shaft 3 is pressed from a back side by a rack guide 15 energized by a rack guide spring 14.

A motor 20 is mounted to an upper portion of the steering gearbox 10. A worm speed reduction mechanism 25 for reducing a driving force of the motor 20 so as to transmit to the steering pinion shaft 13 is constructed within the steering gearbox 10.

The worm speed reduction mechanism 25 is structured such that a worm 27 coaxially connected to a drive shaft of the motor 20 is engaged with a worm wheel 26 fitted and attached to an upper portion of the steering pinion shaft 13.

A number of wheel gears of the worm wheel 26 is 65. A number of worm grooves of the worm 27 is 4. A worm speed reduction ratio is 16.25.

The driving force of the motor 20 is applied to the steering pinion shaft 13 via the worm speed reduction mechanism 25 so as to assist a steering operation.

A torque sensor 30 is provided in a further upper portion of the worm speed reduction mechanism 25.

Reflection discs 31 and 32 are respectively adhered to a side of the input shaft 11 and a side of the steering pinion shaft 13 with 10 respect to the torsion bar 12. An optical module 33 capable of reading bar code patterns 31a and 32a respectively provided in the reflection discs 31 and 32 is attached, whereby the torque sensor 30 is constituted.

The optical module 33 reads the bar code patterns 31a and 32a of the respective reflection discs 31 and 32. The torque sensor 30 detects a torque value on the basis of a difference of angle.

Further, the torque sensor 30 can detect a position of rotation of the steering pinion shaft 13 with respect to a fixed member by reading the bar code pattern 32a of the reflection disc 32 in a side of one steering pinion shaft 13. The torque sensor 30 also serves as a steering pinion shaft rotation position detecting means.

The motor 20 assisting the steering operation is a brushless motor. The motor 20 is structured such that three armature windings Lu, Lv and Lw are formed in eighteen slots. A rotor 21 (not shown in the Figure) in which six magnets comprising N poles and S poles are alternately structured at an interval of 60 degrees, rotates.

When sequentially attaching numbers to eighteen slots around which the armature windings Lu, Lv and Lw are wound and setting them first pole to eighteenth pole, a hole element Hu is arranged between fifteenth pole and sixteenth pole, a hole element Hv is arranged between thirteenth pole and fourteenth pole, and a hole element Hw is arranged between seventeenth pole and eighteenth pole.

Accordingly, an interval of 40 degrees is generated between the hole element Hv and the hole element Hu, and between the hole element Hu and the hole element Hw.

Three hole elements Hu, Hv and Hw can detect six phase states during a rotation of 120 degrees corresponding to a minimum rotation angle at which the rotor 21 rotates and phase states (positions of rotation) of the N pole and the S pole becomes the same.

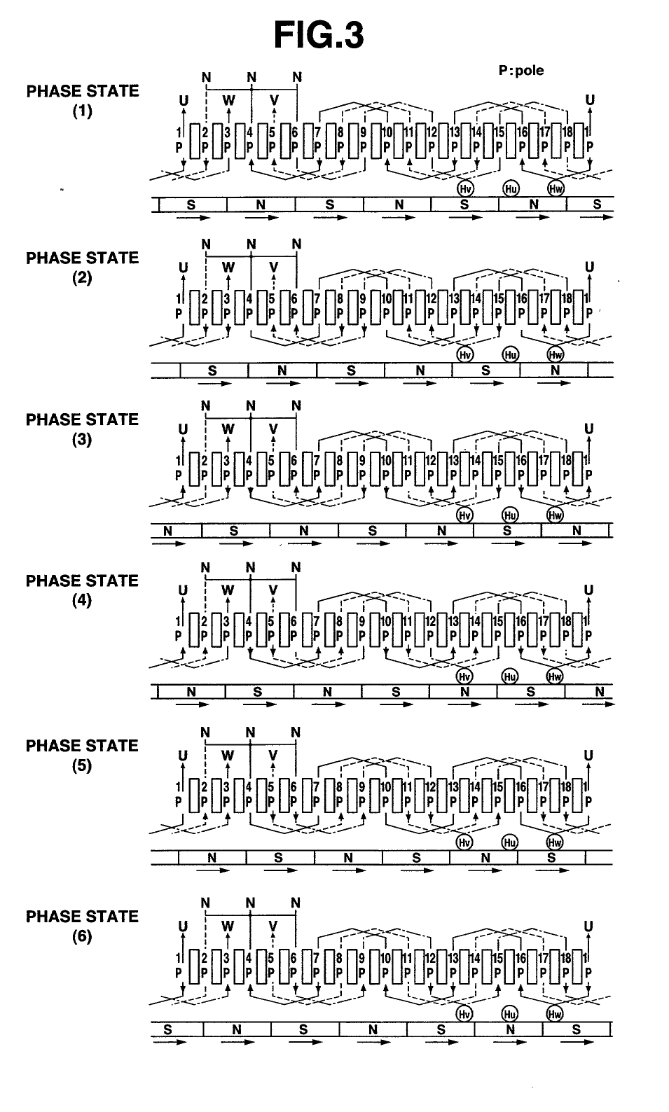

FIG. 3 is a view showing the rotor 21 of the motor 20 and the first pole to the eighteenth pole given by the armature windings Lu, Lv and Lw in a linearly developing manner. Six phase states mentioned above are sequentially illustrated from item (1) to (6).

The hole elements Hu, Hv and Hw sequentially detect the N pole, the S pole and the N pole in a phase state (1), detects the S pole, the S pole and the N pole in a phase state (2) after rotating at 20 degrees therefrom, detects the S pole, the N pole and the N pole in a phase state (3) after rotating at 20 degrees further, detects the S pole, the N pole and the S pole in a phase state (4) after rotating at 20 degrees further, detects the N pole, the N pole and the S pole in a phase state (5) after rotating at 20 degrees further, detects the N pole, the S pole and the S pole in a phase state (6) after rotating at 20 degrees further.

As mentioned above, the different phase states (1), (2), (3), (4), (5) and (6) are sequentially detected at every 20 degrees. The above detection is repeated at three times, whereby the rotor 21 of the motor 20 rotates one lap.

Since the steering (the steering pinion shaft 13) rotates via the worm speed reduction mechanism 25 at a degree of 360/16.25≈22.154 on the basis of the worm speed reduction ratio 16.25 during a period for which the rotor 21 of the motor 20 rotates one lap, the phase state is switched once (the rotor 21 rotates at 20 degrees) and the steering rotates at a degree of 20/16.25≈1.231.

The steering rotates about 1.5 laps from the normal straight traveling state toward a left steering and a right steering, respectively, that is, rotates about three laps from a left steering limit to a right steering limit.

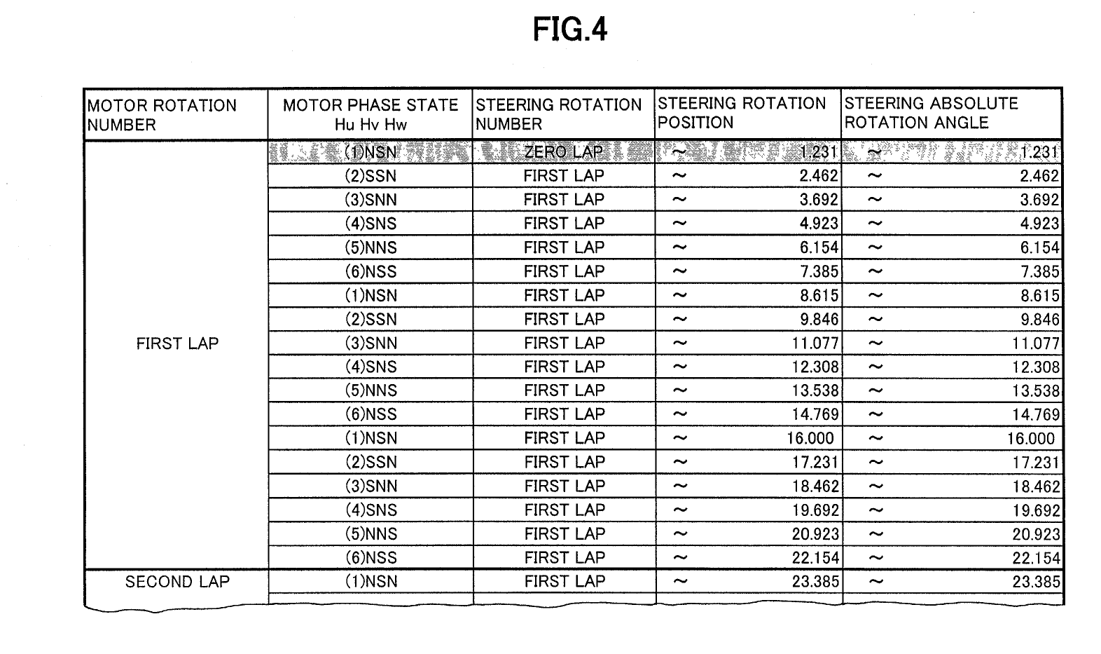

Setting the phase state (1) near the left steering limit to a state such that in a first lap of the motor rotation number, the steering rotation number is 0 lap (start of the first lap), the steering rotation position is between 0 and 1.231 degrees and a steering absolute rotation angle is between 0 and 1.231 degrees. Table 1 in FIG. 4 shows respective changes of the motor rotation number, the motor phase state, the steering rotation number, the steering rotation position and the steering absolute rotation angle until the steering rotation executes about three laps (enters a little into a fourth lap).

In this case, the steering rotation position is a right rotation angular position in the case of setting the start of the phase state (1) near the first left steering limit to 0 degree (reference). The steering rotation position is detected by the optical module 33 of the torque sensor 30 and is returned to 0 degree when the steering rotates one lap at a cycle of 360 degrees.

The steering absolute rotation angle is a right steering (right rotation) absolute angle in the case of setting the start of the phase state (1) near the left steering limit to 0 degree (reference). The steering absolute rotation angle is indicated by a value which is always increased in the right rotation and is reduced in the left rotation without waiting the cycle. All the steering angles of the steering system can be expressed by the steering absolute rotation angle.

As is understood from charts in FIGS. 4 to 7, the motor phase states at the same steering rotation position in the respective laps of the steering rotation number are different from each other.

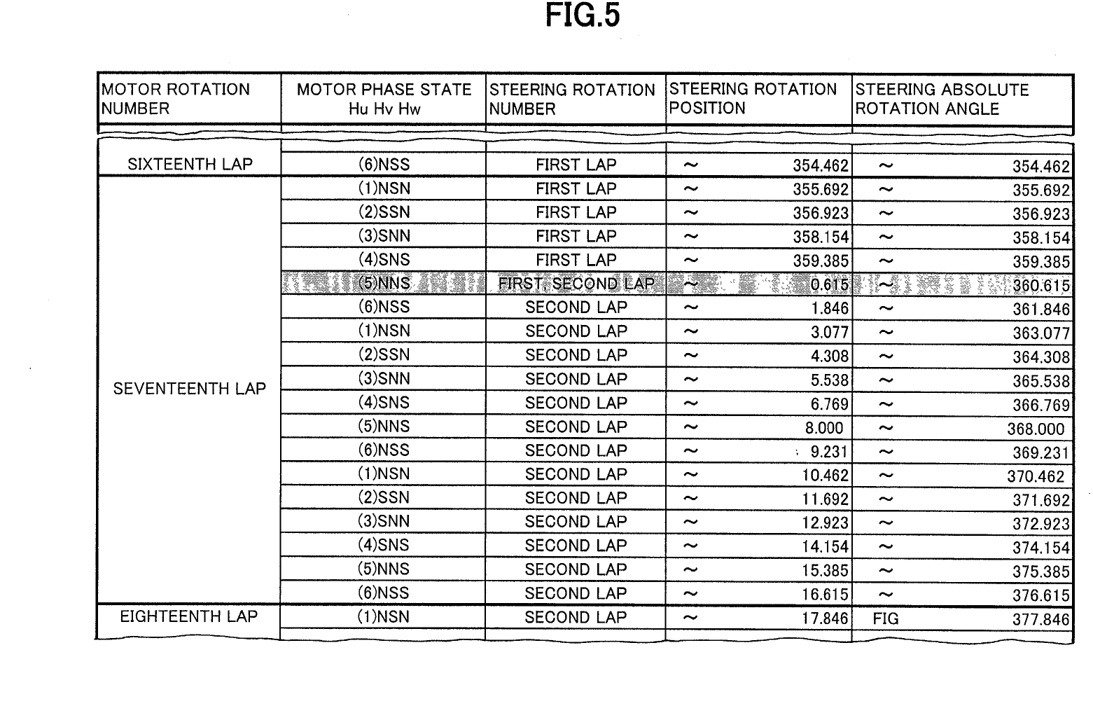

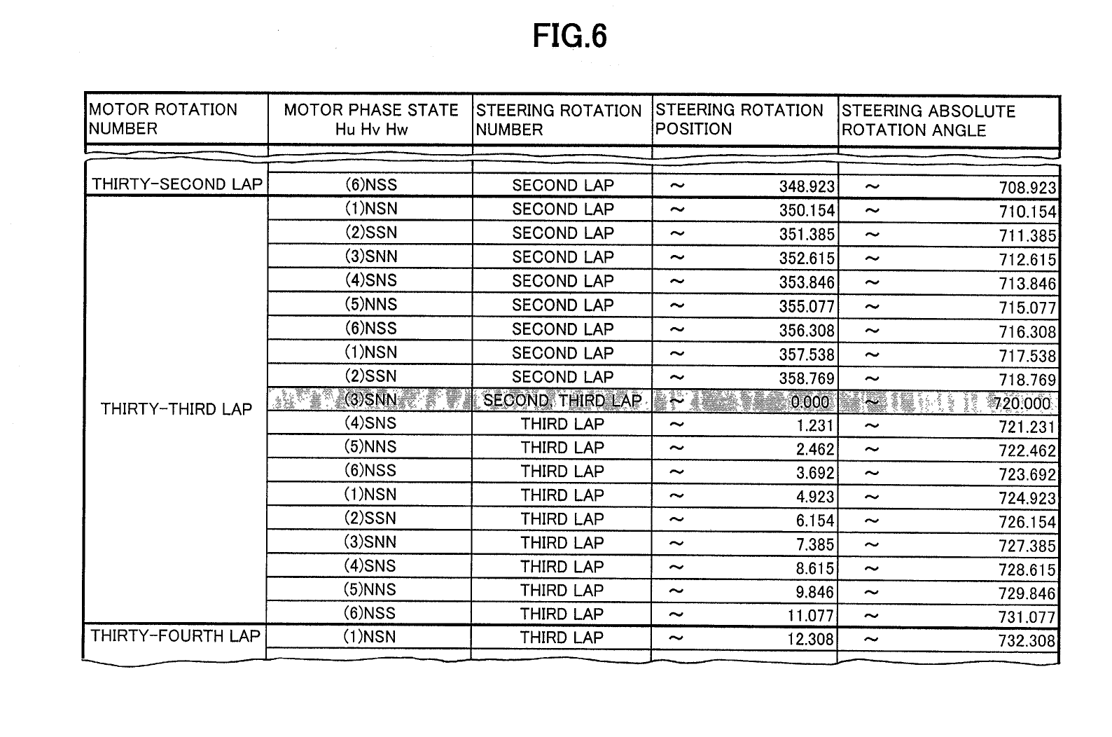

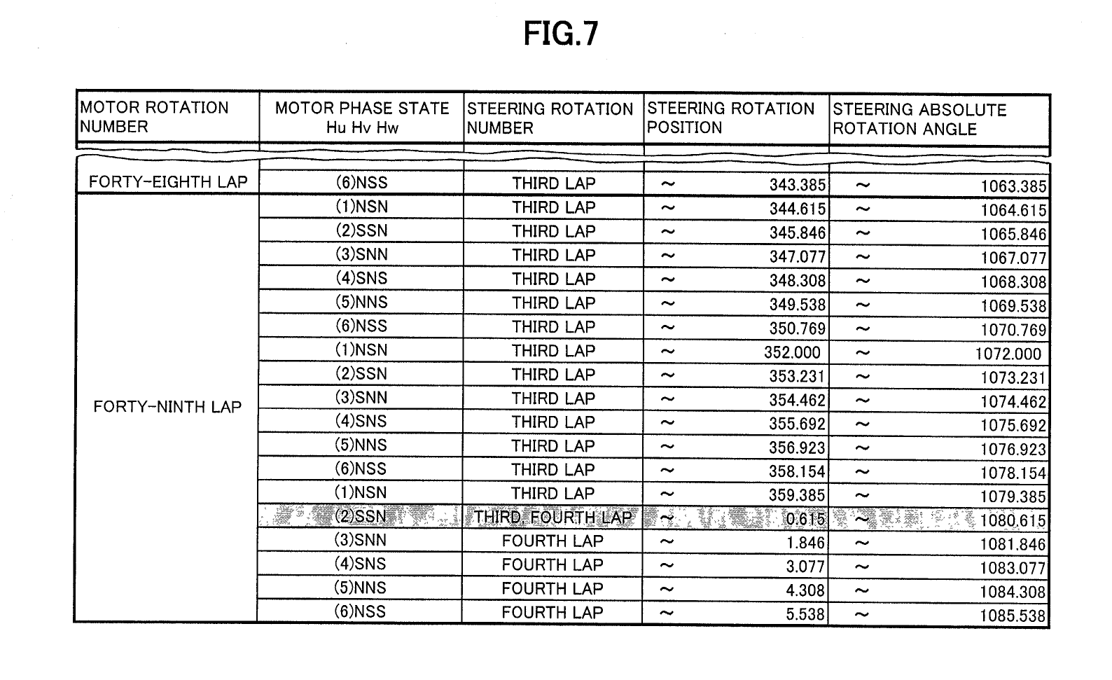

For example, in the case that the steering rotation position is close to 0 degree, the phase state at the first lap (0 lap) of the steering rotation number is (1) (see FIG. 4), the phase state at the second lap is (5) (see FIG. 5), the phase state at the third lap is (3) (see FIG. 6) and the phase state at the fourth lap is (2) (see FIG. 7), and they are in the different states from each other.

This is because the worm speed reduction ratio is set 16.25 and the motor phase state at the same steering rotation position is set so as to be different from each other at the respective laps of the steering rotation number.

Accordingly, at the same steering rotation position, it is known from the phase state of the motor what laps the steering rotation number is, so that the steering angle to about three laps of the steering can be detected by the absolute angle by determining the steering absolute rotation angle by adding 360 degrees to the steering rotation position in the case of the second lap, adding 720 degrees thereto in the case of the third lap, and adding 1080 degrees thereto in the case of the fourth lap.

Then, the computer inputs and computes a steering rotation position signal output from the optical module 33 of the torque sensor 30 and a motor phase state signal output from the hole element so as to calculate the absolute angle of the steering angle.

Since the phase state of the motor 20 is detected by utilizing the hole elements Hu, Hv and Hw detecting the rotation position of the rotor, it is not necessary that an exclusive detecting apparatus is independently provided.

The structure for detecting the rotation position of the rotor includes an optical type, a high frequency induction type, a magnetic resistance element type and the like in addition to the hole element type. However, all of them can be used for detecting the phase state of the motor.

In this case, the steering absolute rotation angle is exemplified by setting the start of the position near the left steering limit to 0 degree (reference). However, the steering neutral position may be set to the reference.

The steering rotation position can be detected by using the optical module 33 of the torque sensor 30. In this case, the exclusive detecting apparatus is not required.

As mentioned above, it is possible to detect the absolute rotation angle of the steering system by the simple structure.

Further, by using the worm speed reduction mechanism 25, it is possible to construct a compact and high speed reduction ratio. Furthermore, it is possible to easily change the speed reduction ratio by setting the number of worm grooves.

The speed reduction ration which can make the motor phase state in the same steering rotation position different from each other in the respective laps of the steering rotation number is not limited to 16.25, and can be suitably changed.

In accordance with the present invention, there is provided a steering rotation angle detecting apparatus of a power steering wherein a driving force of a motor is applied to a steering pinion shaft via a speed reduction mechanism to assist a steering. The steering rotation angle detecting apparatus comprises a steering pinion shaft rotation position detecting means for detecting a rotation position of the steering pinion shaft with respect to a fixed member; a motor phase detecting means for detecting cyclic rotation phase states of the motor; and a steering rotation angle detecting means for detecting an absolute rotation angle over 360 degrees of the steering pinion shaft on the basis of a steering pinion shaft rotation position information detected by the steering pinion shaft rotation position detecting means and a motor phase information detected by the motor phase detecting means.

A speed reduction ratio of the speed reduction mechanism is set so that the rotation phase states of the motor at cycles of 360 degrees of the steering pinion shaft rotation position are different.

Since the speed reduction ratio of the speed reduction mechanism is set so that the rotation phase states of the motor at the cycle of 360 degrees of the steering pinion shaft rotation position are different, the steering rotation angle detecting means can identify the steering pinion shaft rotation position at the cycle of 360 degrees on the basis of the combination between the steering pinion shaft rotation position information and the motor phase information so as to detect the absolute rotation angle over 360 degrees of the steering pinion shaft.

Furthermore, in some embodiments of the steering rotation angle detecting apparatus of the power steering, the speed reduction mechanism is a worm speed reduction mechanism. Advantageously, by using the worm speed reduction mechanism, it is possible to construct the compact and high speed reduction ratio. Further, it becomes easy to change the speed reduction ratio by setting the number of grooves of the worm.

Furthermore, in some embodiments of the steering rotation angle detecting apparatus of the power steering, the steering pinion shaft rotation position detecting means is a rotary encoder which optically reads a pattern provided in a circumference of the steering pinion shaft so as to detect the steering pinion shaft rotation position. Advantageously, it is possible to accurately detect the rotation position of the steering pinion shaft with respect to the fixed member at a low cost by using a general rotary encoder.

Furthermore, in some embodiments of the steering rotation angle detecting apparatus of the power steering, the motor is a brushless motor. The motor phase detecting means is a hole element for detecting the rotation position of the rotor in the motor. Advantageously, it is possible to detect the rotation phase state of the motor on the basis of the hole element detecting the magnetic pole position of the rotor in the motor by using the brushless motor for the motor applied to the steering pinion shaft so as to assist the steering. The apparatus for exclusively detecting the rotation phase state is not independently required and it is possible to achieve a low cost.

As heretofore explained, embodiments of the present invention have been described in detail with reference to the drawings. However, the specific configurations of the present invention are not limited to the embodiments shown and described. Rather, modifications of the design within the range of the present invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiments set out above, but should be understood to include all possible embodiments which can be embodied within a scope encompassed and equivalents thereof with respect to the features set out in the appended claims.

What is claimed is:

1. A steering rotation angle detecting apparatus of a power steering system having a driving force of a motor applied to a steering pinion shaft via a speed reduction mechanism to assist a steering, comprising:
a steering pinion shaft rotation position detecting means for detecting a rotation position of the steering pinion shaft with respect to a fixed member;
a motor phase detecting means for detecting cyclic rotation phase states of the motor; and
a steering rotation angle detecting means for detecting an absolute rotation angle over 360 degrees of the steering pinion shaft on the basis of a steering pinion shaft rotation position information detected by the steering pinion shaft rotation position detecting means and a motor phase information detected by the motor phase detecting means,
wherein a speed reduction ratio of the speed reduction mechanism is set so that the rotation phase states of the motor at cycles of 360 degrees of the steering pinion shaft rotation position are different.

2. A steering rotation angle detecting apparatus of a power steering system according to claim 1, wherein the speed reduction mechanism comprises a worm speed reduction mechanism.

3. A steering rotation angle detecting apparatus of a power steering system according to claim 1, wherein the steering pinion shaft rotation position detecting means comprises a rotary encoder which optically reads a pattern provided in a circumference of the steering pinion shaft so as to detect the steering pinion shaft rotation position.

4. A steering rotation angle detecting apparatus of a power steering system according to claim 2, wherein the steering pinion shaft rotation position detecting means comprises a rotary encoder which optically reads a pattern provided in a circumference of the steering pinion shaft to detect the steering pinion shaft rotation position.

5. A steering rotation angle detecting apparatus of a power steering system according to claim 1, wherein the motor is a brushless motor, and the motor phase detecting means comprises a hole element for detecting the rotation position of the rotor in the motor.

6. A steering rotation angle detecting apparatus of a power steering system according to claim 2, wherein the motor is a brushless motor, and the motor phase detecting means comprises a hole element for detecting the rotation position of the rotor in the motor.

7. A steering rotation angle detecting apparatus of a power steering system according to claim 3, wherein the motor is a brushless motor, and the motor phase detecting means comprises a hole element for detecting the rotation position of the rotor in the motor.

8. A steering rotation angle detecting apparatus of a power steering system according to claim 4, wherein the motor is a brushless motor, and the motor phase detecting means comprises a hole element for detecting the rotation position of the rotor in the motor.

9. A steering rotation angle detecting apparatus of a power steering system according to claim 5, wherein the brushless motor is structured such that three armature windings are formed in eighteen slots, and the rotor in which six magnets comprising N poles and S poles are alternately structured at an interval of 60 degrees, rotates.

10. A steering rotation angle detecting apparatus of a power steering system according to claim 6, wherein the brushless motor is structured such that three armature windings are formed in eighteen slots, and the rotor in which six magnets comprising N poles and S poles are alternately structured at an interval of 60 degrees, rotates.

11. A steering rotation angle detecting apparatus of a power steering system according to claim 7, wherein the brushless motor is structured such that three armature windings are formed in eighteen slots, and the rotor in which six magnets comprising N poles and S poles are alternately structured at an interval of 60 degrees, rotates.

12. A steering rotation angle detecting apparatus of a power steering system according to claim 8, wherein the brushless motor is structured such that three armature windings are formed in eighteen slots, and the rotor in which six magnets comprising N poles and S poles are alternately structured at an interval of 60 degrees, rotates.
